(19) United States
(12) Patent Application Publication
(10) Pub. No.: US 2015/0033066 A1
(43) Pub. Date: Jan. 29, 2015

(54) PARTIAL WRITE ERROR RECOVERY

(71) Applicant: Seagate Technology LLC, Cupertino, CA (US)

(72) Inventor: Sangyun Jung, Gyung-ki do (KR)

(73) Assignee: Seagate Technology LLC, Cupertino, CA (US)

(21) Appl. No.: 13/951,853

(22) Filed: Jul. 26, 2013

(51) Int. Cl. G06F 11/20

(52) U.S. Cl. CPC G06F 11/2017
USPC 714/6.13

(57) ABSTRACT

A data storage device may have at least a qualifier circuit that is configured to recognize a write error during a write operation for a single user data sector on a data storage medium and resume the write operation from the location of the write error by skipping at least one user data sub-sector to provide multiple separate original user data sub-sectors that collectively form the single user data sector.

### SUMMARY

Various embodiments may be directed to a data storage device capable of programming data bits on an associated medium.

In accordance with some embodiments, a qualifier circuit may be configured to recognize a write error during a write operation for a single user data sector on a data storage medium and resume the write operation from the location of the write error by skipping at least one user data sub-sector to provide multiple separate original user data sub-sectors that collectively form the single user data sector.

### BRIEF DESCRIPTION OF THE DRAWINGS

FIG. 1 illustrates a block representation of an example data storage system constructed and operated in accordance with various embodiments.

FIG. 2 shows a portion of an example data track capable of being utilized in the data storage system of FIG. 1.

FIG. 3 displays a portion of an example data track being operated in accordance with some embodiments.

FIG. 4 provides a schematic block representation of an example qualifier circuit configured and operated in accordance with various embodiments.

FIG. 5 illustrates a timing diagram corresponding to an example write operation in a data storage system like the system of FIG. 1.

FIG. 6 is a flow chart for an example partial write error recovery routine illustrative of steps that may be carried out in accordance with various embodiments.

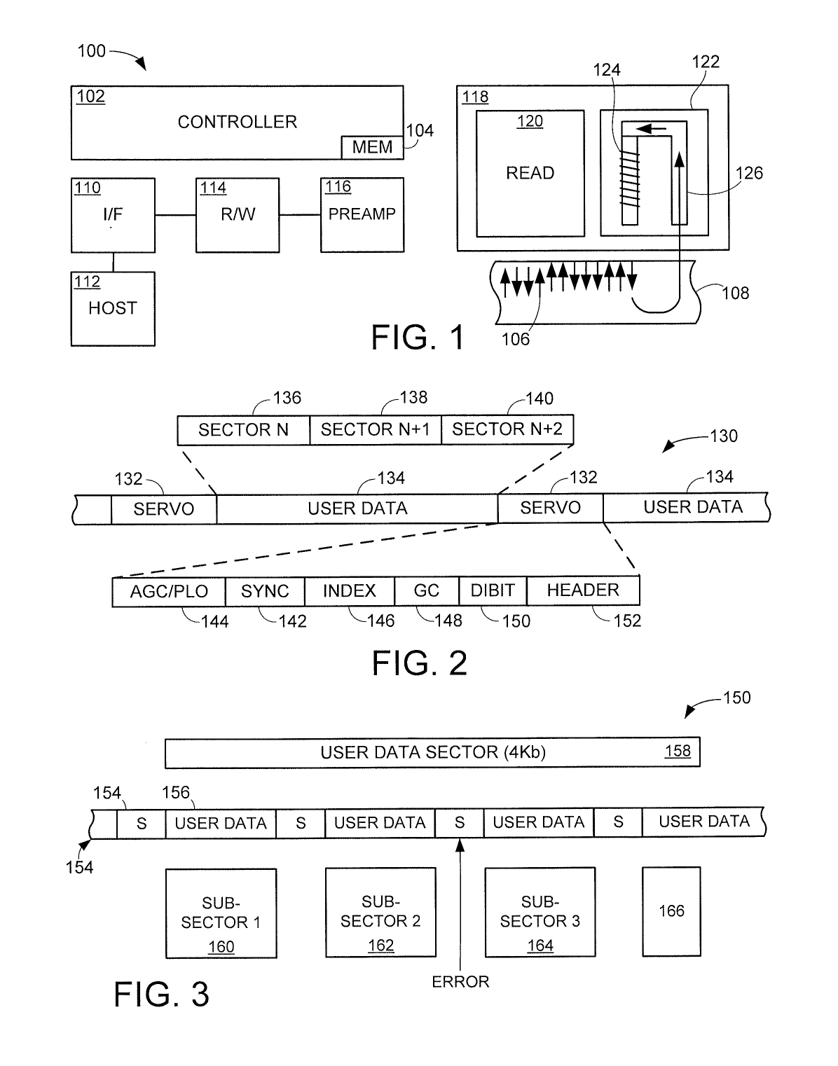

### DETAILED DESCRIPTION

Progression of computing electronics to smaller form factors and increased data capacities has heightened the density of data bits while reducing time available for data access in various data storage devices. Greater data capacities can correspond with larger data sectors that encounter several data overhead regions during a data programming operation for a single data sector. The writing of a single data sector that spans multiple data overhead regions may experience an error that cues rewriting the entire data sector, regardless of how much of the sector were successfully written prior to the experienced error. Thusly, industry has emphasized minimizing the effect data writing errors have on data access times for single data sectors that span a plurality of data overhead regions.

Such industry emphasis has rendered various embodiments to be directed to a data storage device configured at least with a qualifier circuit that recognizes a write error during a write operation for a single user data sector on a data storage medium and resumes the write operation from the location of the write error by skipping at least one user data region to provide multiple separate original user data regions that collectively form the single user data sector. The ability to resume data writing from the point at which the data error occurred allows only the non-programmed portions of the data sector to be written, which contrasts a data writing scheme that rewrites an entire data sector in the event a write error is experienced. With the writing of only the non-programmed portions of a data sector after an error, less time is consumed and data accuracy is improved by not overwriting the existing portions of the data sector.

The following non-limiting embodiments may aid in understanding such features, beginning with a review of FIG. 1, which provides a functional block diagram of an example data storage device 100. The device 100 may take any variety of forms, but is constructed as a hard disc drive (HDD) that stores data to one or more rotatable magnetic recording media in some embodiments while other embodiments may concurrently use a HDD along with solid-state memory in a data storage environment that can be characterized as a hybrid data storage device.

One or more local or remote controllers 102 can provide top level control for the device via wired or wireless communications protocol. At least one controller 102 may be characterized as a hardware or firmware based programmable processor that uses programming and/or control data stored in an associated controller memory (MEM) 104 to access data bits 106 present on a data storage medium 108. An interface (I/F) circuit 110 can communicate with a host device 112 to provide data buffering and post processing capabilities like error detection and correction. A read/write (R/W) circuit 114 conditions received writeback data from the host for storage during a write operation, and reconstructs recovered data to be retrieved to the host during a read operation.

A preamplifier/driver (preamp) circuit 116 can be utilized to provide signal conditioning and driving capabilities for a data transducer 118, such as a transducer head situated as a head gimbal assembly at the end of an actuator. The data transducer 118 may be constructed with any number of separate read 120 and write 122 elements configured to transduce the data bits 106 stored in the rotatable magnetic medium 108. While not limiting, it is contemplated that the read element 120 is a magneto-resistive (MR) lamination of layer and the write element 122 is a perpendicular recording structure that may or may not be associated with heat assist and fly height adjustment capabilities. In operation, the preamp 116 supplies relatively large magnitude, high frequency bipolar write currents to the write element 122, and relatively low magnitude, low frequency read bias currents to the read element 120.

A write driver portion of the preamp 116 may be configured, in various embodiments, to output bipolar write currents to a coil 124 of the write element 122. These write currents may take a non-return to zero (NRZI) format with transitions corresponding to a selected write clock frequency or predetermined pattern. In response to the polarity of the write currents, the coil 124 cooperates with a magnetic core (pole) structure 126 to direct controlled magnetic fields into a recording layer of the medium 108 in a loop, as shown, to impart a predetermined data bit 106 polarity that corresponds with a logical state. While not required or limiting, the magnetic medium 108 may be constructed as a bit patterned media (BPM) that is subjected to suitable lithography steps during manufacture to define an array of discrete, magnetically responsive recordable cells that store individual bits of data. In contrast, the medium 108 can be arranged in the form of concentric data tracks.

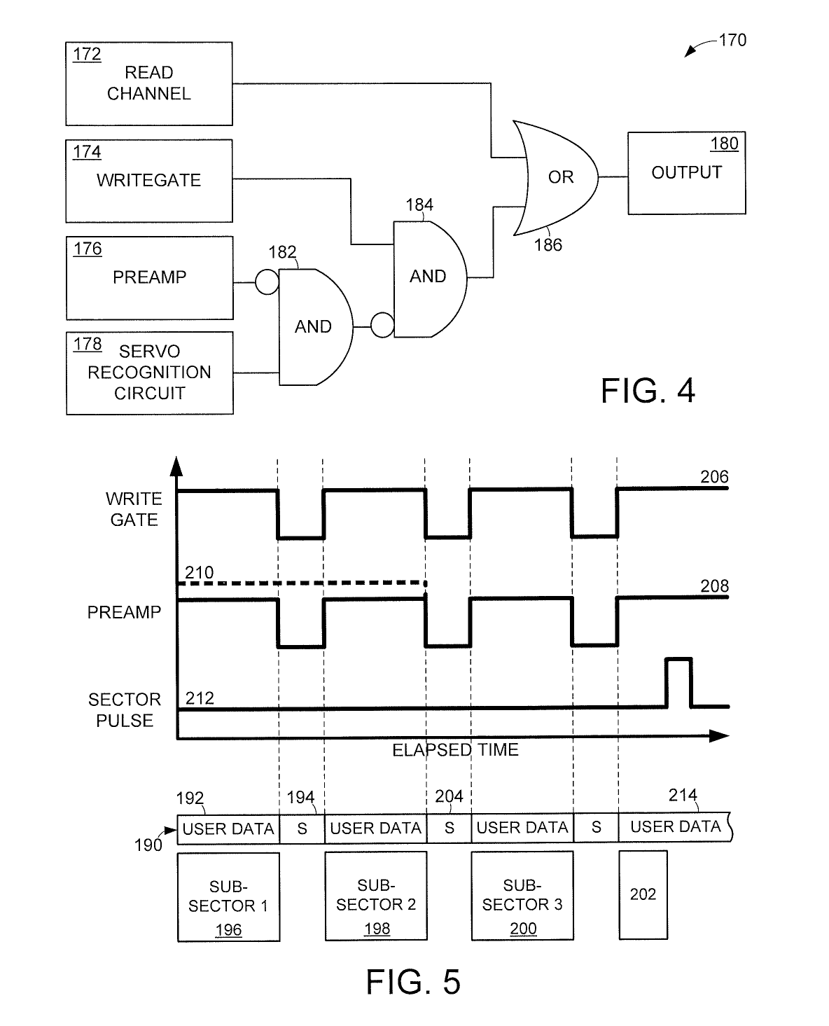

One exemplary format for a data track 130 is represented in FIG. 4. It will be appreciated that any number of formats can be used, so that FIG. 4 is merely for purposes of providing an illustrative example and is not limiting. The exemplary track 130 includes a succession of spaced apart data overhead control fields 132, with user data fields 134 interspersed between each pair of the overhead control fields 132 along the track. In some embodiments, the user data fields 134 may include a number of fixed size user data sectors such as sectors 136, 138 and 140 (denoted as Sectors N, N+1, N+2 . . . ). Each sector may store a fixed amount of encoded user data, such as 512 bytes. Each overhead control field 132 may have at least servo control, timing, header and other types of control data useful in assisting control mechanism of a storage device in correctly positioning read 120 and write 122 elements during read and write operations upon the data sectors 134. Exemplary fields of the overhead control field 132 may include at least a synchronization (sync) field 142, automatic gain control (AGC) field 144, index field 146, Gray code (GC) field 148, servo dibit (ABCD) field 150, and a header field 152.

Generally, the sync field 142 provides a unique bit pattern to enable a readback system to detect the commencement of the control information. The AGC field 144 provides an oscillating pattern (such as a 2T pattern) to enable the readback system to provide both amplitude and phase synchronization. The index field 146 indicates angular position with respect the medium. The GC field indicates radial position (e.g., track address/increment). The servo dibit field 150 provides dibit patterns for intra-track positional control and the header field 152 provides sector address information.

While data may be stored in a data sector having any size and position within a data track 130 and between overhead control fields 132, a data sector may span multiple servo control fields 132 to provide a greater sector size, such as 4 Kb. FIG. 3 is a block representation of a portion of an example data storage medium 150 where data is stored on predetermined tracks 152 with data overhead servo regions 154 positioned at predetermined locations in accordance with some embodiments to separate user data regions 156. The user data regions 156 may be configured to be any size that corresponds to a plurality of sub-sectors 160, 162, 164, and 166 being programmed across several different user data regions 156. Programming the single continuous data sector 158 as a collective group of sub-sector partial writes allows data sector size to extend beyond a single user data region 156 and be tuned for a diverse variety of purposes, such as to store metadata, garbage collection units, and allocation tables.

When a single long data sector like sector 158 is written via several partial writes, effort is taken to protect the servo regions 154 from being compromised with user data. These efforts further allow the servo region 154 to operate to ensure data transducing operations, like data transducer position and timing, are correct and data access has the best possible chance for accurate success. Such servo region 154 operation may yield an error, like an off-track position or estimate seek time error, which immediately suspends data access operations before the error is corrected with at least one data medium rotation. The occurrence of an error during the programming of a long user data sector like sector 158 are conventionally handled by rewriting the entire data sector regardless of the presence of successfully written sub-sectors, such as sub-sectors 160 and 162 of FIG. 3. It can be appreciated that the rewriting of existing data sub-sectors 160 and 162 can be expensive for a data storage system in terms of lost time and system resources, especially in modern computing devices that have lengthy pending command queues and high user demand for near instant system function.

Accordingly, a data storage system may be configured to recognize existing written sub-sectors 160 and 162 in the presence of an error and subsequently resume writing operations from the location of the error to complete the programming of user data sector 158. FIG. 4 provides a schematic view of an example qualifier circuit 170 that can be constructed and operated in accordance with various embodiments to recognize writing errors and written sub-sectors to optimize the recording of user data sectors that span across multiple servo regions. The qualifier circuit can be configured with an unlimited number of inputs that are constructed as similar or dissimilar circuits positioned either locally or remotely. That is, a qualifier circuit 170 can be located in close physical proximity or across a network from one or more input circuits that are respectively and uniquely constructed.

In the example embodiment of FIG. 4, a read channel input 172, writegate channel input 174, preamp input 176, and servo recognition circuit 178 are processed to provide an output 180 that is capable of recognizing previously written user data regions and write errors to resume a writing operation at the location of the encountered error. The qualifier circuit 170 initially compares the preamp 176 and servo recognition 178 signals with an AND logic gate 182 that has an inversion bubble for the preamp signal. Such comparison with logic gate 182 cancels write operation by toggling the preamp signal when an overhead servo region is encountered. The output of logic gate 182 is then compared to the channel writegate input 174 with an AND logic gate 184 having an inversion bubble conditioning the output signal from gate 182. The configuration of the gates 182 and 184 allows previously written user data regions to be skipped by cancelling preamp operation and subsequently resuming the preamp operation at the location of the encountered error.

The conditioning of the preamp input 176 for servo and writegate signals allows the channel to operate normally while the preamp signal is conditioned and toggled based on gates 182 and 184. This tuned configuration of the preamp signal corresponds to the ability to efficiently alter preamp signals compared to channel signals that are fixed during initial manufacturing and difficult to tune while maintaining predetermined operating capabilities, such as data throughput. The writing function output of gate 184 is then compared to the read channel input 172 with an OR logic gate 186 to provide the output 180 for either reading or writing operations. As such, the qualifier circuit 170 can be implemented with a full service data transducer head, such as transducer 118 of FIG. 1, to provide both data reading and writing capabilities.

FIG. 5 generally illustrates a timing diagram for an example qualifier circuit operating on an exemplary portion of a data track 190. The data track 190 is configured with user data regions 192 disposed between servo regions 194 and having user sub-sectors 196 and 198 already written while sub-sectors 200 and 202 are pending to complete the single user data sector due to an error at servo region 204. Solid write gate timing line 206 shows how the channel write gate is toggled in response to a transition between the user data 192 and servo 194 regions of the data track 190. Solid line 208 corresponds to conventional preamp signal where errors and previous written sub-sectors 196 and 198 are ignored. Segmented line 210 displays how a qualifier circuit can selectively toggle preamp function based on the presence of written sub-sectors 196 and 198 with the occurrence of a prior writing error.

As shown with segmented line 210, a qualifier circuit and specifically the preamp can be configured to recognize a write error and suspend writing operations on the previously written user data regions 192 up to the location of the error, at which time sub-sectors 200 and 202 are written without overwriting sub-sectors 196 and 198. Solid line 212 illustrates how a sector pulse indicates the conclusion of a single user data sector, which allows a new user data sector to begin in user data region 214. It is contemplated that the qualifier circuit could be adapted to conduct sub-sector skipping before resuming write operations multiple times for a given single user data sector, which can accommodate the presence of several different errors occurring at the same, or different, times.

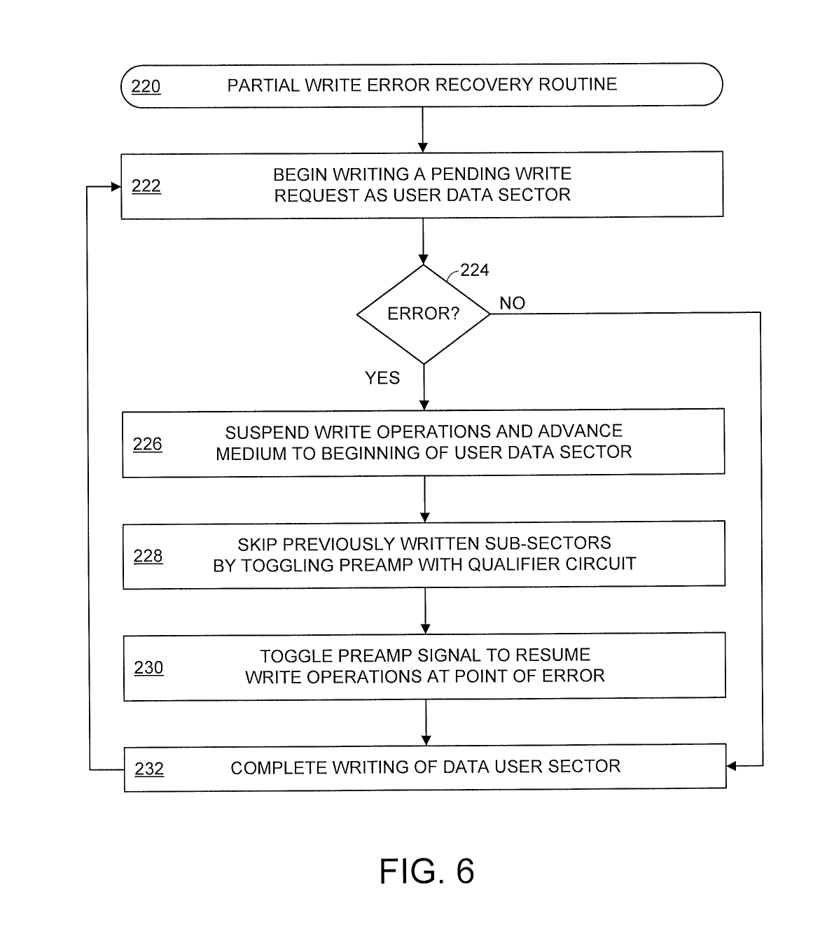

An example partial write error recovery routine 220 that is capable of handling any number of writing errors is mapped in FIG. 6 and carried out in accordance with various embodiments. First, step 222 begins writing a pending write request as a single user data sector. The user data sector may be any size and designated to be stored in a variety of different locations on a data storage medium, but in some embodiments is a size that spans multiple continuous user data and servo regions on the data storage medium. The user data sector may be initially divided into a plurality of sub-sectors of similar and dissimilar sizes that correspond to the size of the user data region of the medium in what can be characterized as a partial writing condition.

The writing of the user data sector with partial writing can encounter a number of different write errors, like off-track errors. Decision 224 can continually or sporadically monitor the data writing operation of step 222 to identify an error has occurred. In the event an error is recognized, a qualifier circuit suspends write operations in step 226 before advancing the data storage medium to the beginning location of the user data sector incurring the error. As can be appreciated, the suspension of write operations in step 226 may be facilitated in an unlimited number of ways, but is performed by toggling a preamp signal with the qualifier circuit. With the write operations suspended, at least one of the user data sectors are skipped as the medium is advanced back to the beginning location of the sector.

Once the qualifier circuit identifies the previously written user data sub-sectors, the preamp signal is toggled to skip the written sub-sectors in step 228. The location of the data transducing means in relation to the data storage medium is then monitored until the previously logged location of the encountered error is reached, which prompts step 230 and the qualifier circuit to resume write operations by toggling the preamp signal. With the toggling of the preamp signal in step 230, nominal preamp conditions are present and writing of the unwritten user sub-sectors is conducted and each encountered servo region is skipped. Completion of the writing of the user data sector in step 232 then advances routine 220 back to step 222 where a new data writing operation begins at a location proximal or distal to the immediately preceding user data sector. Similarly, in the event no errors are encountered during the partial writing of user data sub-sectors that collectively form a user data sector, decision 224 proceeds to step 232 to complete the user data sector before step 222 is revisited.

Through the tuned configuration and operation of a qualifier circuit, erroneous user sub-sector overwriting subsequent to an encountered error can be eliminated. FIG. 6 generally provides an example manner in which a qualifier circuit can operate. However, the steps and decision of routine 220 are not required or limiting as any number of actions and determinations can be conducted at will. For instance, an additional step may be implemented into routine 220 to immediately read verify a user data sub-sector to ensure the partial write properly recorded the data, which can complement the timing and positional data accuracy mechanism provided by the servo regions of a data track.

With the operation of a tuned qualifier circuit, system time and processing can be saved by resuming suspended write operation at the point of error instead of at the beginning of the user data sector in which the error occurred. The capability to handle such errors allows for the use of extended size user data sectors that span multiple different user data regions of a data medium and are programmed via a number of partial sector writes. Such extended size user data sectors can provide optimized data organization, especially in modern computing devices where sophisticated overhead data, like allocation tables, garbage collection units, and metadata, are frequently being updated via write operations.

It should be noted that while the embodiments herein have been directed to write operations on a rotating data medium, it will be appreciated that the various embodiments can readily be utilized in any number of other applications, including solid-state memory devices and cloud computing environments. It is to be understood that even though numerous characteristics and configurations of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. For example, the particular elements may vary depending on the particular application without departing from the spirit and scope of the present technology.

What is claimed is:

1. An apparatus comprising a qualifier circuit configured to recognize a write error during a write operation for a single user data sector on a data storage medium and resume the write operation from the location of the write error by skipping at least one user data sub-sector to provide multiple separate original user data sub-sectors that collectively form the single user data sector.

2. The apparatus of claim 1, wherein the data storage medium is part of a hard disc drive (HDD).

3. The apparatus of claim 1, wherein the data storage medium and qualifier circuit are implemented in a hybrid data storage device with at least one solid-state memory array.

4. The apparatus of claim 1, wherein the write operation is conducted by an associated data transducer.

5. The apparatus of claim 4, wherein the data transducer has both data reading and data writing means.

6. The apparatus of claim 1, wherein the single user data sector has a first size that is greater than a second size of the at least one user data region of the data storage medium.

7. The apparatus of claim 1, wherein the separate original user data regions are separated by servo regions of the data storage medium.

8. The apparatus of claim 1, wherein the qualifier circuit comprises preamp, writegate, servo recognition circuit, and read channel inputs.

9. The apparatus of claim 8, wherein the preamp, writegate, and servo recognition circuit inputs are connected via first and second logic gates.

10. A method comprising:
configuring a qualifier circuit to recognize a write error during a write operation for a single user data sector on a data storage medium; and
resuming the write operation from the location of the write error by skipping at least one previously written user data sub-sector to provide multiple separate original user data sub-sectors that collectively form the single user data sector.

11. The method of claim 10, wherein the write error comprises an off-track position error.

12. The method of claim 10, wherein the write error comprises an estimated seek time error.

13. The method of claim 10, wherein the resuming step toggles a preamp input of the qualifier circuit.

14. The method of claim 10, wherein the write operation writes a first user data sub-sector before skipping an intervening servo region of the data storage medium and subsequently writing a second user data sub-sector.

15. The method of claim 10, wherein the qualifier circuit conducts an AND logic comparison between a preamp and channel write gate signals with the preamp signal being inverted.

16. The method of claim 10, wherein the qualifier circuit conducts an AND logic comparison between a preamp and servo recognition circuit signals with the preamp signal being inverted.

17. The method of claim 10, wherein the single user data sector is written via a plurality of separate partial writes.

18. A method comprising:
configuring a qualifier circuit to recognize a write error during a write operation for a single user data sector on a data storage medium;
suspending the write operation by skipping at least one user data sub-sector of the single user data sector; and
resuming the write operation from the location of the write error by skipping at least one previously written user data sub-sector to provide multiple separate original user data sub-sectors that collectively form the single user data sector.

19. The method of claim 18, wherein the suspended write operation advances the data storage medium to a starting location of the write operation.

20. The method of claim 18, wherein the user data sub-sectors skipped during the suspending step have pending user data write requests and the user data sub-sector skipped during the resuming step have no pending user data write requests.
